(19) United States
(12) Patent Application Publication
(10) Pub. No.: US 2026/0136289 A1
(43) Pub. Date: May 14, 2026

(54) JOINT ON-DEMAND OTHER SYSTEM INFORMATION AND SYSTEM INFORMATION BLOCK 1

(71) Applicant: QUALCOMM Incorporated, San Diego, CA (US)

(72) Inventors: Jianghong LUO, Skillman, NJ (US); Navid ABEDINI, Basking Ridge, NJ (US); Hung Dinh LY, San Diego, CA (US); Ahmed Attia ABOTABL, San Diego, CA (US)

(21) Appl. No.: 19/372,849

(22) Filed: Oct. 29, 2025

Related U.S. Application Data
(60) Provisional application No. 63/718,470, filed on Nov. 8, 2024.

(51) Int. Cl. H04W 52/02

(52) U.S. Cl. CPC H04W 52/0235

(57) ABSTRACT

Methods, systems, and devices for wireless communications are described. A user equipment (UE) may receive a control signal indicating an uplink wake up signal (WUS) configuration. The UE may transmit an uplink WUS that requests an on-demand system information block 1(SIB1) and on-demand other system information based on the uplink wake up signal configuration. The UE may receive the on-demand SIB1 during a first monitoring window based on the uplink wake up signal that requests the on-demand other system information and the on-demand SIB1. The UE may receive the on-demand other system information during one or more second monitoring windows based on the uplink wake up signal that requests the on-demand other system information and the on-demand SIB1.

### CROSS REFERENCES

The present Application for Patent claims benefit of U.S. Provisional Ser. No. 63/718,470 by LUO et al., entitled “JOINT ON-DEMAND OTHER SYSTEM INFORMATION AND SYSTEM INFORMATION BLOCK 1,” filed Nov. 8, 2024 and assigned to the assignee hereof. U.S. Provisional Ser. No. 63/718,470 is expressly incorporated herein in its entirety.

### INTRODUCTION

The following relates to wireless communications, including joint on-demand other system information and system information block 1 (SIB1).

Wireless communication systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communication system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a control signal indicating an uplink wake up signal (WUS) configuration, transmitting an uplink WUS that requests an on-demand system information block 1 (SIB1) and on-demand other system information based on the uplink WUS configuration, receiving the on-demand SIB1 during a first monitoring window based on the uplink WUS that requests the on-demand other system information and the on-demand SIB1, and receiving the on-demand other system information during one or more second monitoring windows based on the uplink WUS that requests the on-demand other system information and the on-demand SIB1.

A UE for wireless communications is described. The UE may include one or more memories storing processor executable code, and one or more processors coupled with the one or more memories. The one or more processors may individually or collectively be operable to execute the code to cause the UE to receive a control signal indicating an uplink WUS configuration, transmit an uplink WUS that requests an on-demand SIB1 and on-demand other system information based on the uplink WUS configuration, receive the on-demand SIB1 during a first monitoring window based on the uplink WUS that requests the on-demand other system information and the on-demand SIB1, and receive the on-demand other system information during one or more second monitoring windows based on the uplink WUS that requests the on-demand other system information and the on-demand SIB1.

Another UE for wireless communications is described. The UE may include means for receiving a control signal indicating an uplink WUS configuration, means for transmitting an uplink WUS that requests an on-demand SIB1 and on-demand other system information based on the uplink WUS configuration, means for receiving the on-demand SIB1 during a first monitoring window based on the uplink WUS that requests the on-demand other system information and the on-demand SIB1, and means for receiving the on-demand other system information during one or more second monitoring windows based on the uplink WUS that requests the on-demand other system information and the on-demand SIB1.

A non-transitory computer-readable medium storing code for wireless communications is described. The code may include instructions executable by one or more processors to receive a control signal indicating an uplink WUS configuration, transmit an uplink WUS that requests an on-demand SIB1 and on-demand other system information based on the uplink WUS configuration, receive the on-demand SIB1 during a first monitoring window based on the uplink WUS that requests the on-demand other system information and the on-demand SIB1, and receive the on-demand other system information during one or more second monitoring windows based on the uplink WUS that requests the on-demand other system information and the on-demand SIB1.

In some examples of the method, UEs, and non-transitory computer-readable medium described herein, transmitting the uplink WUS may include operations, features, means, or instructions for transmitting assistance information associated with the on-demand other system information.

In some examples of the method, UEs, and non-transitory computer-readable medium described herein, the assistance information may be based on a random access preamble used for the uplink WUS or random access channel resources used to transmit the uplink WUS.

In some examples of the method, UEs, and non-transitory computer-readable medium described herein, the assistance information indicates a system information area identifier, one or more value tags for one or more other system information, a radio resource control (RRC) connection status of the UE, a first request for the on-demand SIB1, a second request for the on-demand other system information and the on-demand SIB1, or any combination thereof.

In some examples of the method, UEs, and non-transitory computer-readable medium described herein, the uplink WUS configuration identifies one or more other system information that may be triggered in response to the uplink WUS that requests the on-demand SIB1 and the on-demand other system information.

In some examples of the method, UEs, and non-transitory computer-readable medium described herein, the on-demand SIB1 indicates scheduling information for the one or more second monitoring windows for the on-demand other system information.

Some examples of the method, UEs, and non-transitory computer-readable medium described herein may further include operations, features, means, or instructions for receiving, in response to the uplink WUS, a random access response message that indicates scheduling information for the one or more second monitoring windows for the on-demand other system information or identities of one or more other system information that may be triggered in response to the uplink WUS.

In some examples of the method, UEs, and non-transitory computer-readable medium described herein, the random access response message indicates timing information, including a reference time and an offset from the reference time, for a third window that includes the one or more second monitoring windows.

In some examples of the method, UEs, and non-transitory computer-readable medium described herein, the reference time corresponds to a reception of the random access response message, a start of a random access response window, or an end of the random access response window.

In some examples of the method, UEs, and non-transitory computer-readable medium described herein, the uplink WUS configuration indicates scheduling information or search space information for the one or more second monitoring windows for the on-demand other system information.

In some examples of the method, UEs, and non-transitory computer-readable medium described herein, the uplink WUS configuration includes a first configuration for a first random access channel resource associated with requesting the on-demand SIB1 and a second configuration for a second random access channel resource associated with requesting the on-demand SIB1 and the on-demand other system information and the first random access channel resource and the second random access channel resource each include a random access preamble and a set of time and frequency resources.

In some examples of the method, UEs, and non-transitory computer-readable medium described herein, the uplink WUS configuration indicates timing information, including a reference time and an offset from the reference time, for a third window that includes the one or more second monitoring windows.

In some examples of the method, UEs, and non-transitory computer-readable medium described herein, the reference time corresponds to a reception of the on-demand SIB1, a start of the first monitoring window, or an end of the first monitoring window.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communication system that supports joint on-demand other system information and system information block 1 (SIB1) in accordance with one or more aspects of the present disclosure.

FIG. 2 shows an example of a wireless communication system that supports joint on-demand other system information and SIB1 in accordance with one or more aspects of the present disclosure.

FIG. 3 shows an example of a process flow that supports joint on-demand other system information and SIB1 in accordance with one or more aspects of the present disclosure.

FIGS. 4 and 5 show block diagrams of devices that support joint on-demand other system information and SIB1 in accordance with one or more aspects of the present disclosure.

FIG. 6 shows a block diagram of a communications manager that supports joint on-demand other system information and SIB1 in accordance with one or more aspects of the present disclosure.

FIG. 7 shows a diagram of a system including a device that supports joint on-demand other system information and SIB1 in accordance with one or more aspects of the present disclosure.

FIGS. 8 through 10 show flowcharts illustrating methods that support joint on-demand other system information and SIB1 in accordance with one or more aspects of the present disclosure.

### DETAILED DESCRIPTION

A wireless communication system may implement techniques to provide network energy savings. For example, the wireless communication system may implement on-demand system information, where a network entity transmits system information on-demand, such as in response to an uplink wake up signal (WUS) from a user equipment (UE), instead of periodically broadcasting the system information. Some systems support on-demand system information blocks (SIBs), such as on-demand system information block 1 (SIB1). In some cases, a system may also support on-demand other system information, or SIBs besides SIB1. SIB1 may indicate a configuration for PDCCH monitoring occasions for other the on-demand other system information. Additionally, SIB1 may indicate value tags for other SIBs. If the UE has previously stored SIBs and the value tags for the stored SIBs match the value tags indicated by the SIB1, the information of the stored SIBs may still be valid. If the value tags of the stored SIBs do not match the value tag indicated by the SIB1, the stored SIBs may be outdated and invalid. In current systems, a UE may transmit a WUS (e.g., including a random access channel request) to request on-demand SIB1. The UE may transmit a second random access channel request to request on-demand other system information for any SIBs that are invalid according to the value tag of the SIB1. However, transmitting multiple random access channel requests may lead to higher power consumption, random access channel resource overhead, and network interference.

A UE may transmit an uplink WUS to request both on-demand SIB1 and on-demand other system information. For example, transmission of SIB1 and a subset of other system information may be triggered by same uplink WUS transmission. The subset of other system information triggered by the uplink WUS may be semi-statically configured by an uplink WUS configuration. Additionally, or alternatively, the uplink WUS may include assistance information, which may request certain other system information or include information which enables the network to determine which other system information stored at the UE is invalid. Scheduling information for monitoring windows for the other system information may be indicated via the uplink WUS configuration, the on-demand SIB1, or a random access response message received in response to the uplink WUS.

Aspects of the disclosure are initially described in the context of wireless communication systems. Aspects of the disclosure are further illustrated by and described with reference to apparatus diagrams, system diagrams, and flowcharts that relate to joint on-demand other system information and SIB1.

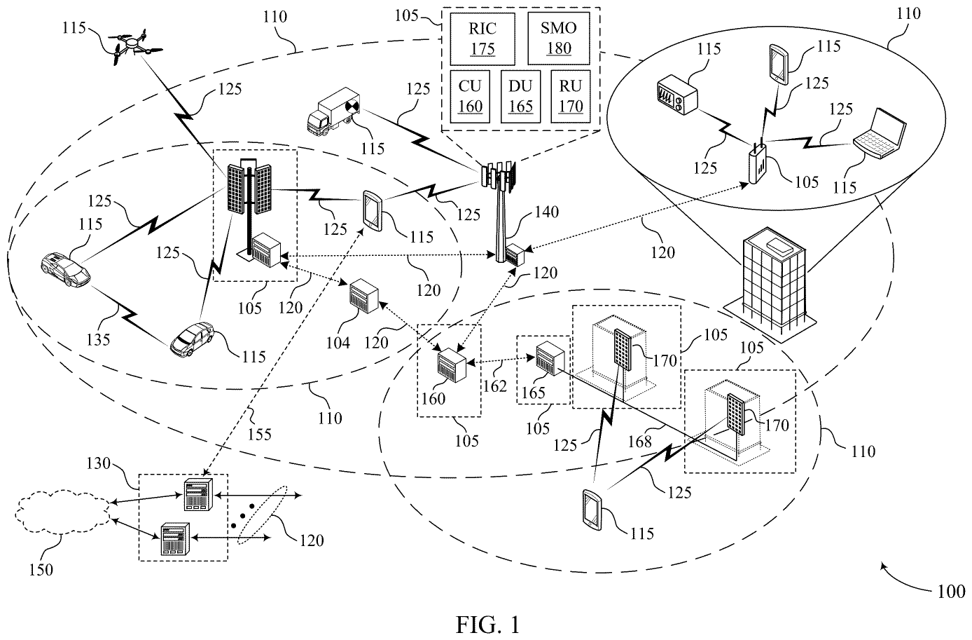

FIG. 1 shows an example of a wireless communication system 100 that supports joint on-demand other system information and SIB1 in accordance with one or more aspects of the present disclosure. The wireless communication system 100 may include one or more devices, such as one or more network devices (e.g., network entities 105), one or more UEs 115, and a core network 130. In some examples, the wireless communication system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communication system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communication system 100, and each UE 115 may be stationary or mobile at different times. The UEs 115 may be devices in different forms or having different capabilities. Some example UEs 115 are illustrated in FIG. 1. The UEs 115 described herein may be capable of supporting communications with various types of devices in the wireless communication system 100 (e.g., other wireless communication devices, including UEs 115 or network entities 105), as shown in FIG. 1.

As described herein, a node of the wireless communication system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130 or with one another. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communication systems (e.g., the wireless communication system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support joint on-demand other system information and SIB1 as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communication system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communication system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communication system 100 (e.g., the network entities 105, the UEs 115, or both) may have hardware configurations that support communications using a particular carrier bandwidth or may be configurable to support communications using one of a set of carrier bandwidths. In some examples, the wireless communication system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communication resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communication systems, such as the wireless communication system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., a quantity of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communication system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communication system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communication system 100 may utilize both licensed and unlicensed RF spectrum bands. For example, the wireless communication system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communication system 100 may implement techniques to provide network energy savings. For example, the wireless communication system 100 may implement on-demand system information, where a network entity 105 transmits system information on-demand, such as in response to an uplink WUS, instead of periodically broadcasting the system information. The uplink WUS may include, or be an example of, a physical random access channel (PRACH) transmission. For example, the uplink WUS may include, or be an example of, a PRACH preamble.

Some systems support on-demand SIBs, such as on-demand SIB1. In some cases, a UE 115 operating in an idle mode or an inactive mode may transmit an uplink WUS to request on-demand SIB1. The UE 115 may obtain an uplink WUS configuration from a serving cell and transmit an uplink WUS on a network energy savings cell. The UE 115 may receive on-demand SIB1 from the network energy savings cell. In some examples, the network energy savings cell may transmit a random access response message in response to the uplink WUS. In some examples, the network energy savings cell and the serving cell may be the same, or the network energy savings cell and the serving cell may be difference cells.

SIB1 may indicate a configuration for physical downlink control channel (PDCCH) monitoring occasions for other system information, or SIBs besides SIB1. For example, SIB1 may indicate a search space for the other system information, including an associated physical PDCCH control resource set for the other system information. In some examples, the SIB1 may indicate scheduling information for system information windows for the other system information. The UE 115 may monitor PDCCH occasions for other system information during the system information windows.

In some cases, a system may also support on-demand other system information. SIB1 may indicate information for on-demand other system information. For example, SIB1 may indicate whether other system information is being broadcasted or whether on-demand other system information is available. In some examples, SIB1 may indicate a configuration for requesting on-demand other system information. Additionally, SIB1 may indicate value tags for the other system information. If the UE has previously stored SIBs and the value tags for the stored SIBs match the value tags indicated by the SIB1, the information of the stored SIBs may still be valid. If the value tags of the stored SIBs do not match the value tag indicated by the SIB1, the stored SIBs may be outdated and invalid.

If the UE 115 receives an acknowledgment for the system information request, the UE 115 may monitor for the on-demand other system information within system information windows indicated by the SIB1. For example, upon receipt of the random access response message, the UE 115 may monitor one or more system information windows until successful acquisition of the other system information, at least within a current modification period of the system information.

Within a system information window, there may be a one-to-one mapping between synchronization signal blocks (SSBs) and PDCCH occasions. Other system information may be beam-swept overall transmitted SSBs at least once. The UE 115 may select an SSB and monitor for other system information in a PDCCH occasion corresponding to the SSB.

In current systems, a UE 115 may transmit a WUS (e.g., including a random access channel request) to request on-demand SIB1. The UE 115 may transmit a second random access channel request to request on-demand other system information for any SIBs that are invalid according to the value tag of the SIB1. However, transmitting multiple random access channel requests may lead to higher power consumption, random access channel resource overhead, and network interference.

A wireless communication system described herein may support techniques for a joint PRACH request for on-demand SIB1 and on-demand other system information. For example, a UE 115 may trigger transmission of SIB1 and a subset of other system information with a single uplink WUS. The subset of other system information triggered by the uplink WUS may be semi-statically configured by an uplink WUS configuration. Additionally, or alternatively, the uplink WUS may include assistance information, which may request certain other system information or include information which enables the network to determine which other system information stored at the UE 115 is invalid. Scheduling information for monitoring windows for the other system information may be indicated via the uplink WUS configuration, the on-demand SIB1, or a random access response message received in response to the uplink WUS.

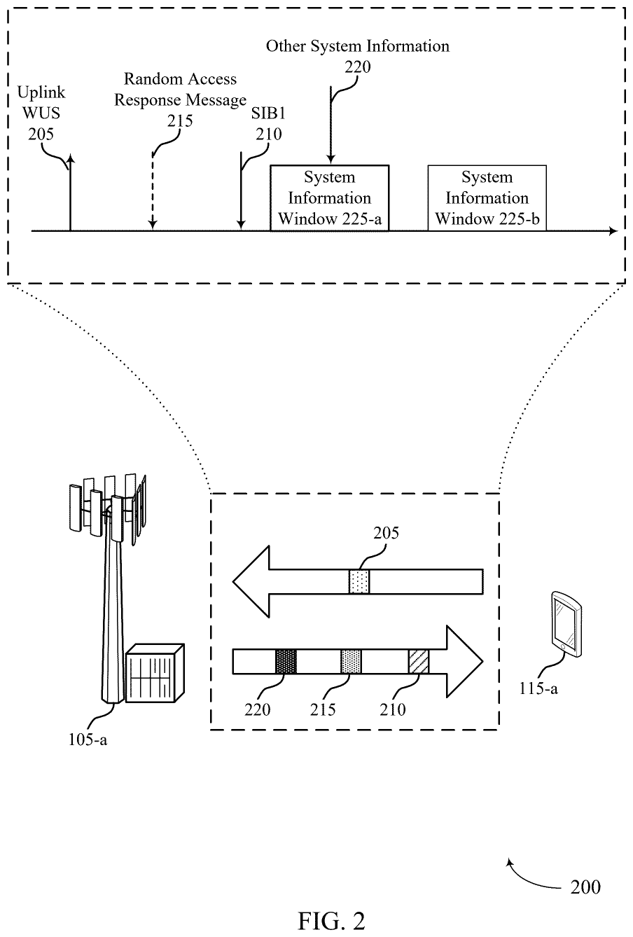

FIG. 2 shows an example of a wireless communication system 200 that supports joint on-demand other system information and SIB1 in accordance with one or more aspects of the present disclosure. The wireless communication system 200 may implement aspects of a wireless communication system 100. For example, the wireless communication system 200 may include a UE 115-a and a network entity 105-a, which may be respective examples of a UE 115 and a network entity 105 described herein.

The network entity 105-a may provide, or be an example of, a network energy savings cell. The UE 115-a and the network entity 105-a may support on-demand system information, such as on-demand SIB1 and on-demand other system information. For example, the UE 115-a may transmit an uplink WUS 205, and the network entity 105-a may transmit an on-demand SIB1 210 or on-demand other system information 220 in response to the uplink WUS 205. The uplink WUS 205 may be an example of or include a PRACH preamble.

The wireless communication system 200 may support techniques for a joint PRACH request for both on-demand SIB1 and on-demand other system information. With a joint PRACH request for both the on-demand SIB1 210 and the on-demand other system information 220, transmission of a subset of other system information (e.g., SIBs besides SIB1) may be triggered with the on-demand SIB1 210 by a same uplink WUS transmission.

For example, the UE 115-a may transmit an uplink WUS 205, which may jointly request the on-demand SIB1 210 and the on-demand other system information 220. The UE 115-a may receive the on-demand SIB1 210 in response to the uplink WUS 205. In some examples, the on-demand SIB1 may indicate monitoring occasion information for one or more system information windows 225. The UE 115-a may monitor the one or more system information windows 225 for the on-demand other system information 220. For example, the UE 115-a may monitor a system information window 225-a for the on-demand other system information 220. In some examples, the UE 115-a may monitor multiple system information windows (e.g., the system information window 225-a and a system information window 225-b, among others) for multiple other system information blocks.

In some examples, the uplink WUS 205 may request the on-demand SIB1 210 and a subset of other system information, or SIBs other than SIB1. on-demand other system information 220 triggered by the uplink WUS 205 may include some major or high priority other system information. In some examples, the uplink WUS may trigger other system information or SIBs that convey information for idle mode UEs 115. For example, the uplink WUS may trigger SIB2, SIB3, SIB4, or SIB17, or any combination thereof. In some examples, a network energy saving cell's other system information may share a same system information area identifier as associated serving cells. In some examples, other system information of the network energy saving cell which is shared with associated serving cells may not be automatically triggered, and other system information which is not shared with associated serving cells may be triggered by the uplink WUS 205.

In some examples, a subset of other system information that can be triggered with the on-demand SIB1 210 may be configured by an uplink WUS configuration. For example, the uplink WUS configuration may include information associated with on-demand SIB1 (e.g., how to trigger on-demand SIB1) and information associated with on-demand other system information. In some examples, the uplink WUS configuration may indicate which other system information is triggered when the UE 115-a transmits the uplink WUS 205 to request both the on-demand SIB1 210 and the on-demand other system information 220. The other system information that is triggered with on-demand SIB1 by a single uplink WUS may be semi-statically configured or reconfigured.

In some examples, the subset of other system information that can be triggered with an on-demand SIB1 may be dynamically indicated by a random access response message 215 for the on-demand SIB1. For example, the network entity 105-b may transmit a random access response message 215 in response to the uplink WUS 205. The random access response message 215 may indicate the subset of other system information that is triggered by the uplink WUS 205.

In some examples, the uplink WUS 205 may include assistance information associated with on-demand other system information. For example, the network entity 105-a may determine whether to trigger the on-demand other system information 220 with the on-demand SIB1 210 based on the assistance information. In some examples, the network entity 105-a may determine a subset of other system information to be triggered with the on-demand SIB1.

In some examples, if the uplink WUS 205 is based on Message 1 of a random access procedure (e.g., a four-step random access procedure), the assistance information may be indicated via separate PRACH preambles or separate time-frequency resources. For example, transmission of the uplink WUS 205 may indicate some assistance information from the UE 115-a. For example, via a selection of random access preamble, time-frequency resource, or random access occasion, the UE 115-a may indicate some assistance information associated with on-demand SIB1 or on-demand other system information. In some examples, if the uplink WUS 205 is based on Message 3 or Message A (e.g., of a four-step random access procedure or a two-step random access procedure, respective), the assistance information may be indicated inside the uplink WUS 205. For example, a payload of the uplink WUS 205 may indicate the assistance information.

In some examples, the assistance information may identify a requested subset of other system information. For example, the UE 115-a may request one or more SIBs other than SIB1. In some examples, the assistance information may indicate whether the UE 115-a is requesting the on-demand SIB1 210 or both the on-demand SIB1 210 and the on-demand other system information 220. In some examples, the assistance information may indicate connection information of the UE 115-a. For example, the assistance information may indicate whether the UE 115-a wants to or expects to establish a connection and transition out of an idle or inactive mode, or whether the UE 115-a is to remain in an idle or inactive mode. In some examples, the network entity 105-a may trigger the on-demand SIB1 210 and not the on-demand other system information 220 if the UE 115-a expects to establish a connection soon (e.g., within a threshold duration of time). Otherwise, the network entity 105-a may trigger transmission of both the on-demand SIB1 210 and the on-demand other system information 220.

In some examples, the assistance information may indicate information on other system information stored at the UE 115-a. For example, the assistance information may indicate system information area identifiers for the other system information stored at the UE 115-a. In some examples, the assistance information may indicate a value tag of the other system information stored at the UE 115-a. The network entity 105-a may receive the assistance information (e.g., via the uplink WUS 205 or an accompanying PRACH transmission) and determine which other system information stored at the UE 115-a are valid or invalid. The network entity 105-a may trigger transmission of other system information which is invalid at the UE 115-a based on the assistance information.

A PDCCH monitoring configuration for the on-demand other system information 220 triggered by the uplink WUS 205 may be indicated via the SIB1 210, an uplink WUS configuration, or the random access response message 215, or any combination thereof. In some examples, the PDCCH monitoring configuration may reuse a partial or the full configuration for PDCCH monitoring for other system information indicated by the on-demand SIB1 210. For example, the UE 115-a may monitor PDCCH monitoring occasions within a system information window 225 for the on-demand other system information 220 according to a configuration indicated by the SIB1 210.

If part of a configuration for monitoring for other system information is indicated by the SIB1 210, a remaining part of the configuration for monitoring for the on-demand other system information 220 may be indicated via the uplink WUS configuration or the random access response message 215. For example, a window including one or more system information windows may be configured via the uplink WUS configuration or the random access response message 215. The window may be specified by a starting time relative to a reference time and the duration. The reference time may be based on the on-demand SIB1 210 (e.g., the reference time may correspond to a reception time of the on-demand SIB1 210) or a PDCCH monitoring window for the on-demand SIB1 210.

In some examples, a PDCCH monitoring configuration for the on-demand other system information 220 triggered by the uplink WUS 205 may be indicated via the uplink WUS configuration. For example, the uplink WUS configuration may indicate a search space for other system information or system information scheduling information. In this example, the UE 115-a may begin monitoring for on-demand other system information after reception of the random access response message 215 to the uplink WUS 205. The UE 115-a may reuse a same PDCCH monitoring window for on-demand SIB1 configured by the uplink WUS configuration to determine which system information windows to monitor for the on-demand other system information 220. In some examples, a window including one or more system information windows 225 may be configured via the uplink WUS configuration or the random access response message 215. The window may be specified by a starting time relative to a reference time and the duration. The reference time may be based on the random access response message 215 (e.g., the reference time may correspond to a reception time of the random access response message 215) or a window for the random access response message 215 (e.g., a start or end of the window for the random access response message 215).

In some examples, the uplink WUS configuration may configure two types of PRACH resources for requesting the on-demand SIB1 210. For example, the uplink WUS configuration may configure a first set of PRACH resources including a first PRACH preamble and first time-frequency resources and a second set of PRACH resources including a second PRACH preamble and second time-frequency resources. The UE 115-a may transmit the uplink WUS 205 using the first set of PRACH resources to request the on-demand SIB1 210. In some examples, the first set of PRACH resources may be an example of a first type of PRACH resources, and the second set of PRACH resources may be an example of a second type of PRACH resources. The UE 115-a may transmit the uplink WUS 205 using the second set of PRACH resources to request both the on-demand SIB1 210 and the on-demand other system information 220. In some examples, the network entity 105-a may configure just the first set of PRACH resources to support on-demand SIB1 and not on-demand other system information. If both sets of PRACH resources are configured, the UE 115-a may determine which set of PRACH resources to use when transmitting the uplink WUS 205.

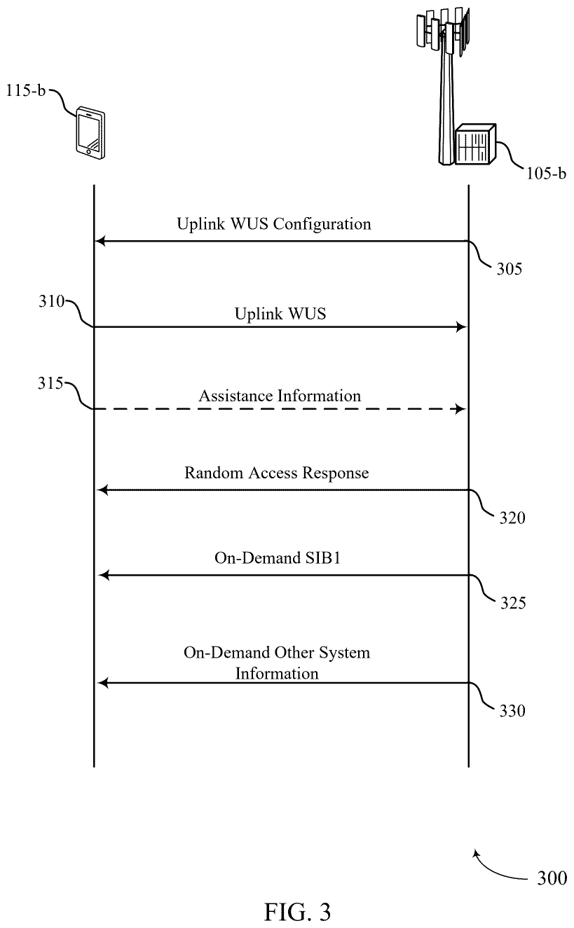

FIG. 3 shows an example of a process flow 300 that supports joint on-demand other system information and SIB1 in accordance with one or more aspects of the present disclosure. The process flow 300 may implement aspects of a wireless communication system 100 and a wireless communication system 200 described herein. For example, the process flow 300 may be implemented by a UE 115-b and a network entity 105-b, which may be respective examples of a UE 115 and a network entity 105 described herein.

Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 300, some aspects of some operations may also be performed by one or more other wireless devices.

At 305, the UE 115-b may receive an uplink WUS configuration from the network entity 105-b. For example, the UE 115-b may receive a control signal indicating an uplink WUS configuration. In some examples, the UE 115-b may receive the uplink WUS configuration from a first cell, such as a first cell which transmits periodic SIB1. In some examples, the network entity 105-a may provide the first cell.

In some examples, the uplink WUS configuration may identify one or more other system information that are triggered in response to an uplink WUS that requests on-demand SIB1 and on-demand other system information. In some examples, the uplink WUS configuration may indicate scheduling information or search space information for the one or more monitoring windows for on-demand other system information. In some examples, the uplink WUS configuration indicates timing information, including a reference time and an offset from the reference time, for another window that includes the one or more monitoring windows. The reference time may correspond to a reception of an on-demand SIB1, a start of a monitoring window for the SIB1, or an end of the monitoring window for the SIB1.

At 310, the UE 115-b may transmit an uplink WUS. The uplink WUS may request an on-demand SIB1 and on-demand other system information based on the uplink WUS configuration. In some examples, the UE 115-b may transmit the uplink WUS to a network energy savings cell. In some examples, the network entity 105-b may provide the network energy savings cell. In some other examples, separate network entities may provide the first cell and the network energy savings cell.

In some examples, the uplink WUS may include assistance information. For example, the UE 115-b may transmit assistance information associated with the on-demand other system information. The assistance information may be included in the uplink WUS, or the assistance information may be transmitted separately at 315. The assistance information may be based on a random access preamble used for the uplink WUS or random access channel resources used to transmit the uplink WUS.

In some examples, the assistance information may indicate information for other system information stored at the UE 115-b. For example, the assistance information indicates a system information area identifier or one or more value tags for one or more other system information stored at the UE 115-b. In some examples, the assistance information may indicate an RRC connection status of the UE 115-b. For example, the assistance information may indicate whether the UE 115-b is to enter an RRC connected mode or stay in an RRC idle or RRC inactive mode. In some examples, the assistance information may include a first request for the on-demand SIB1, a second request for the on-demand other system information and the on-demand SIB1, or any combination thereof. In some examples, the assistance information may request specific SIBs for the on-demand other system information.

In some examples, at 320, the UE 115-b may receive a random access response message in response to the uplink WUS. The random access response message may indicate scheduling information for the one or more monitoring windows for the on-demand other system information. In some examples, the random access response message may identify one or more other system information that are triggered in response to the uplink WUS. In some examples, the random access response message indicates timing information, including a reference time and an offset from the reference time, for another window that includes the one or more second monitoring windows. The reference time may correspond to a reception of the random access response message, a start of a random access response window, or an end of the random access response window.

At 325, the UE 115-b may receive the on-demand SIB1. For example, the UE 115-b may receive the on-demand SIB1 during a first monitoring window based on the uplink WUS that requests the on-demand other system information and the on-demand SIB1. At 330, the UE 115-b may receive the on-demand other system information during one or more second monitoring windows based on the uplink WUS signal that requests the on-demand other system information and the on-demand SIB1.

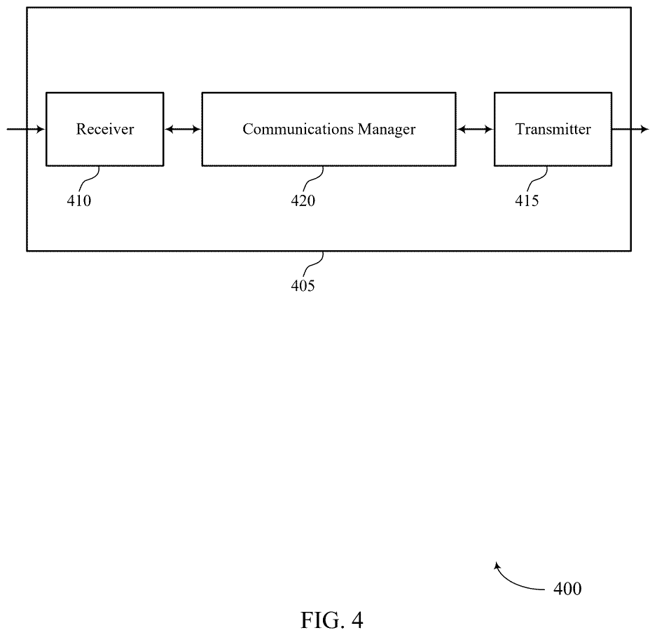

FIG. 4 shows a block diagram 400 of a device 405 that supports joint on-demand other system information and SIB1 in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to joint on-demand other system information and SIB1). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to joint on-demand other system information and SIB1). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of joint on-demand other system information and SIB1 as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410 or the transmitter 415. For example, the communications manager 420 may receive information from the receiver 410, send information to the transmitter 415, or be integrated in combination with the receiver 410 or the transmitter 415 to obtain information, output information, or perform various other operations as described herein.

The communications manager 420 may support wireless communications in accordance with examples as disclosed herein. For example, the communications manager 420 is capable of, configured to, or operable to support a means for receiving a control signal indicating an uplink WUS configuration. The communications manager 420 is capable of, configured to, or operable to support a means for transmitting an uplink WUS that requests an on-demand SIB1 and on-demand other system information based on the uplink WUS configuration. The communications manager 420 is capable of, configured to, or operable to support a means for receiving the on-demand SIB1 during a first monitoring window based on the uplink WUS that requests the on-demand other system information and the on-demand SIB1. The communications manager 420 is capable of, configured to, or operable to support a means for receiving the on-demand other system information during one or more second monitoring windows based on the uplink WUS that requests the on-demand other system information and the on-demand SIB1.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced power consumption and more efficient utilization of communication resources.

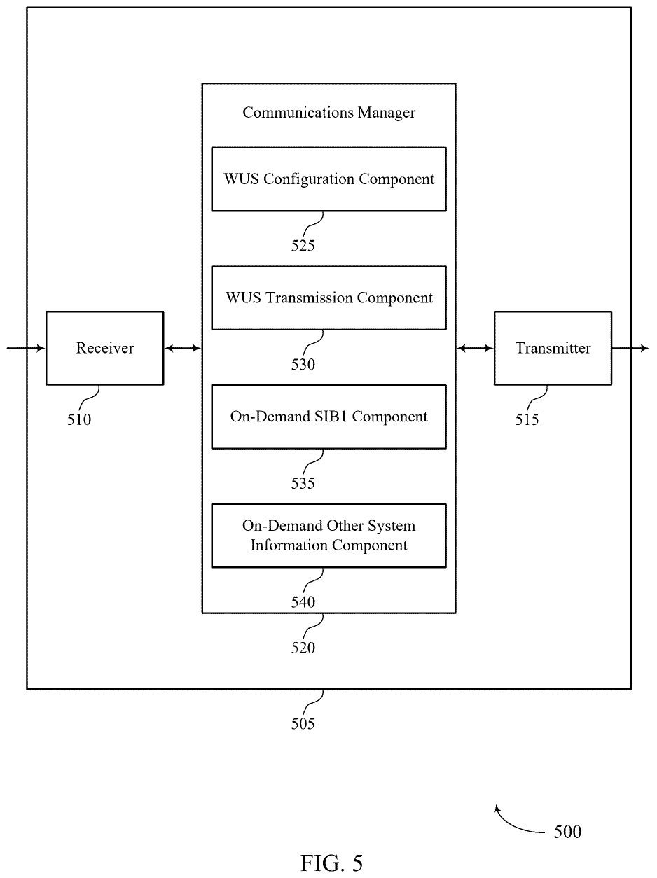

FIG. 5 shows a block diagram 500 of a device 505 that supports joint on-demand other system information and SIB1 in accordance with one or more aspects of the present disclosure. The device 505 may be an example of aspects of a device 405 or a UE 115 as described herein. The device 505 may include a receiver 510, a transmitter 515, and a communications manager 520. The device 505, or one of more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to joint on-demand other system information and SIB1). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to joint on-demand other system information and SIB1). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of joint on-demand other system information and SIB1 as described herein. For example, the communications manager 520 may include a WUS configuration component 525, a WUS transmission component 530, an on-demand SIB1 component 535, an on-demand other system information component 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510 or the transmitter 515. For example, the communications manager 520 may receive information from the receiver 510, send information to the transmitter 515, or be integrated in combination with the receiver 510 or the transmitter 515 to obtain information, output information, or perform various other operations as described herein.

The communications manager 520 may support wireless communications in accordance with examples as disclosed herein. The WUS configuration component 525 is capable of, configured to, or operable to support a means for receiving a control signal indicating an uplink WUS configuration. The WUS transmission component 530 is capable of, configured to, or operable to support a means for transmitting an uplink WUS that requests an on-demand SIB1 and on-demand other system information based on the uplink WUS configuration. The on-demand SIB1 component 535 is capable of, configured to, or operable to support a means for receiving the on-demand SIB1 during a first monitoring window based on the uplink WUS that requests the on-demand other system information and the on-demand SIB1. The on-demand other system information component 540 is capable of, configured to, or operable to support a means for receiving the on-demand other system information during one or more second monitoring windows based on the uplink WUS that requests the on-demand other system information and the on-demand SIB1.

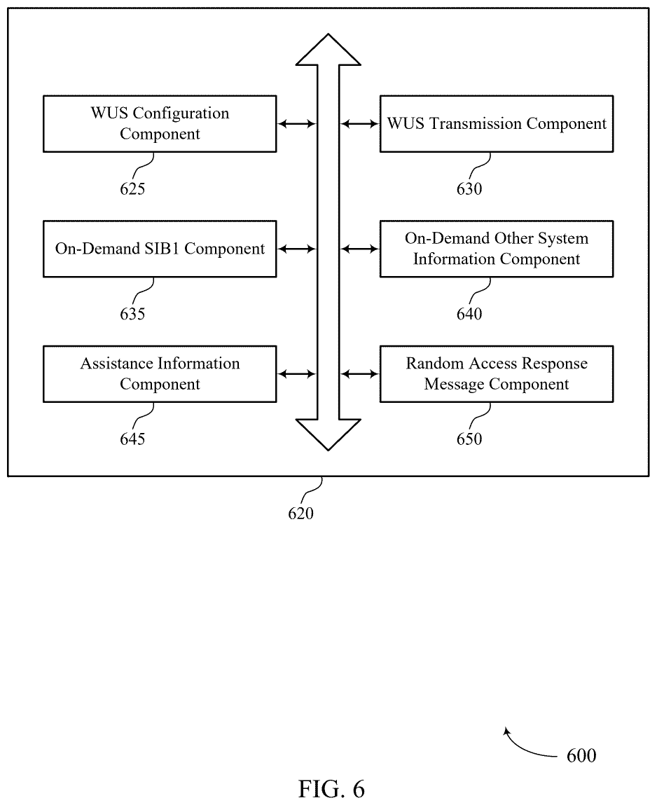

FIG. 6 shows a block diagram 600 of a communications manager 620 that supports joint on-demand other system information and SIB1 in accordance with one or more aspects of the present disclosure. The communications manager 620 may be an example of aspects of a communications manager 420 or a communications manager 520 as described herein. The communications manager 620, or various components thereof, may be an example of means for performing various aspects of joint on-demand other system information and SIB1 as described herein. For example, the communications manager 620 may include a WUS configuration component 625, a WUS transmission component 630, an on-demand SIB1 component 635, an on-demand other system information component 640, an assistance information component 645, a random access response message component 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The WUS configuration component 625 is capable of, configured to, or operable to support a means for receiving a control signal indicating an uplink WUS configuration. The WUS transmission component 630 is capable of, configured to, or operable to support a means for transmitting an uplink WUS that requests an on-demand SIB1 and on-demand other system information based on the uplink WUS configuration. The on-demand SIB1 component 635 is capable of, configured to, or operable to support a means for receiving the on-demand SIB1 during a first monitoring window based on the uplink WUS that requests the on-demand other system information and the on-demand SIB1. The on-demand other system information component 640 is capable of, configured to, or operable to support a means for receiving the on-demand other system information during one or more second monitoring windows based on the uplink WUS that requests the on-demand other system information and the on-demand SIB1.

In some examples, to support transmitting the uplink WUS, the assistance information component 645 is capable of, configured to, or operable to support a means for transmitting assistance information associated with the on-demand other system information.

In some examples, the assistance information is based on a random access preamble used for the uplink WUS or random access channel resources used to transmit the uplink WUS. In some examples, the assistance information is indicated via a payload of the uplink WUS.

In some examples, the assistance information indicates a system information area identifier, one or more value tags for one or more other system information, an RRC connection status of the UE, a first request for the on-demand SIB1, a second request for the on-demand other system information and the on-demand SIB1, or any combination thereof.

In some examples, the uplink WUS configuration identifies one or more other system information that are triggered in response to the uplink WUS that requests the on-demand SIB1 and the on-demand other system information.

In some examples, the on-demand SIB1 indicates scheduling information for the one or more second monitoring windows for the on-demand other system information.

In some examples, the random access response message component 650 is capable of, configured to, or operable to support a means for receiving, in response to the uplink WUS, a random access response message that indicates scheduling information for the one or more second monitoring windows for the on-demand other system information or identifiers of one or more other system information that are triggered in response to the uplink WUS.

In some examples, the random access response message indicates timing information, including a reference time and an offset from the reference time, for a third window that includes the one or more second monitoring windows.

In some examples, the reference time corresponds to a reception of the random access response message, a start of a random access response window, or an end of the random access response window.

In some examples, the uplink WUS configuration indicates scheduling information or search space information for the one or more second monitoring windows for the on-demand other system information.

In some examples, the uplink WUS configuration indicates timing information, including a reference time and an offset from the reference time, for a third window that includes the one or more second monitoring windows.

In some examples, the reference time corresponds to a reception of the on-demand SIB1, a start of the first monitoring window, or an end of the first monitoring window.

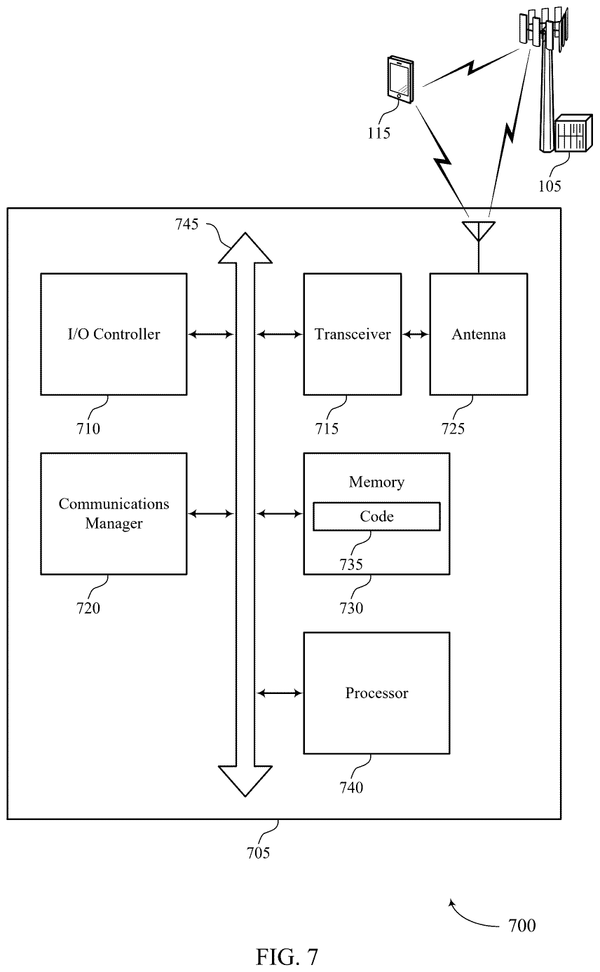

FIG. 7 shows a diagram of a system 700 including a device 705 that supports joint on-demand other system information and SIB1 in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting joint on-demand other system information and SIB1). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving a control signal indicating an uplink WUS configuration. The communications manager 720 is capable of, configured to, or operable to support a means for transmitting an uplink WUS that requests an on-demand SIB1 and on-demand other system information based on the uplink WUS configuration. The communications manager 720 is capable of, configured to, or operable to support a means for receiving the on-demand SIB1 during a first monitoring window based on the uplink WUS that requests the on-demand other system information and the on-demand SIB1. The communications manager 720 is capable of, configured to, or operable to support a means for receiving the on-demand other system information during one or more second monitoring windows based on the uplink WUS that requests the on-demand other system information and the on-demand SIB1.

By including or configuring the communications manager 720 in accordance with examples as described herein, the device 705 may support techniques for reduced power consumption, more efficient utilization of communication resources, and longer battery life.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of joint on-demand other system information and SIB1 as described herein, or the at least one processor 740 and the at least one memory 730 may be otherwise configured to, individually or collectively, perform or support such operations.

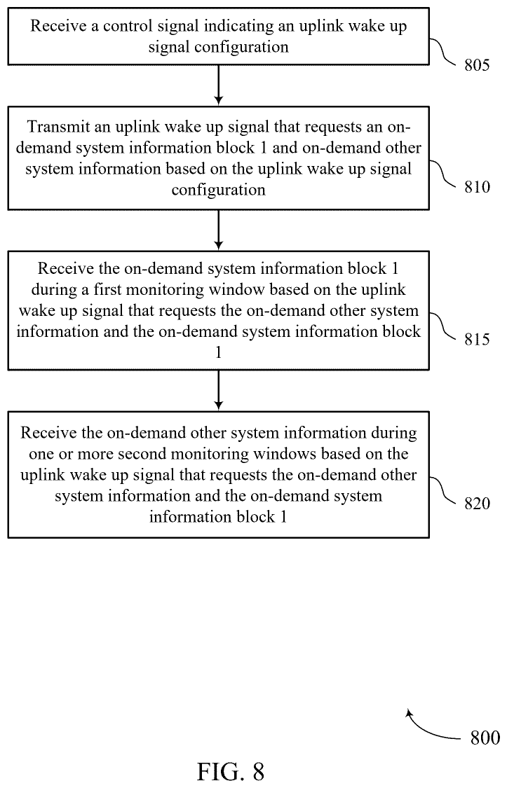

FIG. 8 shows a flowchart illustrating a method 800 that supports joint on-demand other system information and SIB1 in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving a control signal indicating an uplink WUS configuration. The operations of 805 may be performed in accordance with examples as disclosed herein. In some examples, aspects of the operations of 805 may be performed by a WUS configuration component 625 as described with reference to FIG. 6.

At 810, the method may include transmitting an uplink WUS that requests an on-demand SIB1 and on-demand other system information based on the uplink WUS configuration. The operations of 810 may be performed in accordance with examples as disclosed herein. In some examples, aspects of the operations of 810 may be performed by a WUS transmission component 630 as described with reference to FIG. 6.

At 815, the method may include receiving the on-demand SIB1 during a first monitoring window based on the uplink WUS that requests the on-demand other system information and the on-demand SIB1. The operations of 815 may be performed in accordance with examples as disclosed herein. In some examples, aspects of the operations of 815 may be performed by an on-demand SIB1 component 635 as described with reference to FIG. 6.

At 820, the method may include receiving the on-demand other system information during one or more second monitoring windows based on the uplink WUS that requests the on-demand other system information and the on-demand SIB1. The operations of 820 may be performed in accordance with examples as disclosed herein. In some examples, aspects of the operations of 820 may be performed by an on-demand other system information component 640 as described with reference to FIG. 6.

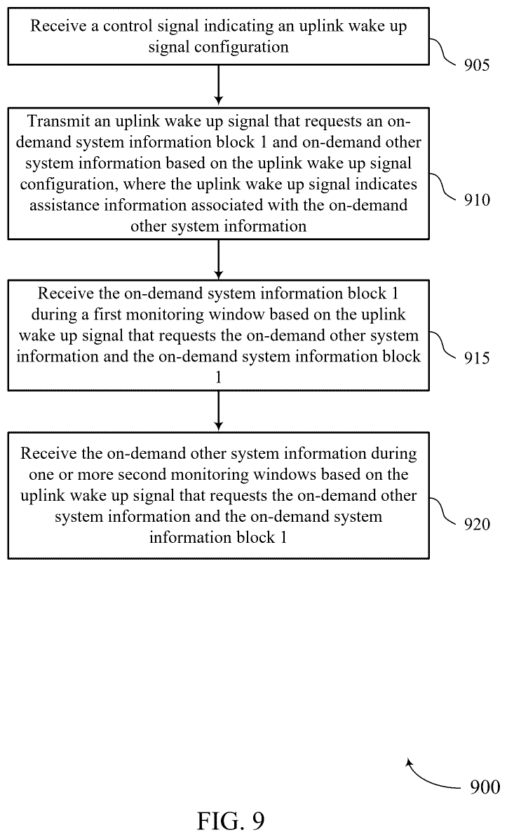

FIG. 9 shows a flowchart illustrating a method 900 that supports joint on-demand other system information and SIB1 in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving a control signal indicating an uplink WUS configuration. The operations of 905 may be performed in accordance with examples as disclosed herein. In some examples, aspects of the operations of 905 may be performed by a WUS configuration component 625 as described with reference to FIG. 6.

At 910, the method may include transmitting an uplink WUS that requests an on-demand SIB1 and on-demand other system information based on the uplink WUS configuration, where the uplink WUS indicates assistance information associated with the on-demand other system information. The operations of 910 may be performed in accordance with examples as disclosed herein. In some examples, aspects of the operations of 910 may be performed by a WUS transmission component 630 as described with reference to FIG. 6.

At 915, the method include receiving the on-demand SIB1 during a first monitoring window based on the uplink WUS that requests the on-demand other system information and the on-demand SIB1. The operations of 915 may be performed in accordance with examples as disclosed herein. In some examples, aspects of the operations of 915 may be performed by an on-demand SIB1 component 635 as described with reference to FIG. 6.

At 920, the method may include receiving the on-demand other system information during one or more second monitoring windows based on the uplink WUS that requests the on-demand other system information and the on-demand SIB1. The operations of 920 may be performed in accordance with examples as disclosed herein. In some examples, aspects of the operations of 920 may be performed by an on-demand other system information component 640 as described with reference to FIG. 6.

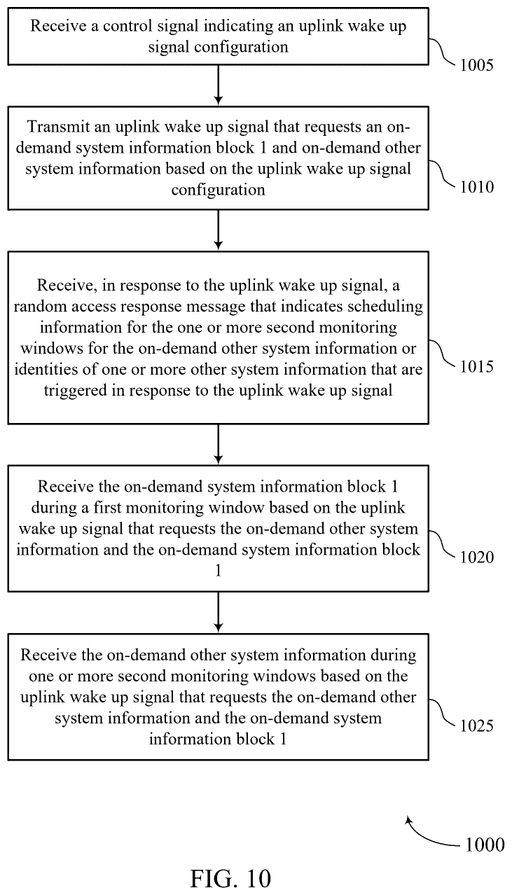

FIG. 10 shows a flowchart illustrating a method 1000 that supports joint on-demand other system information and SIB1 in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include receiving a control signal indicating an uplink WUS configuration. The operations of 1005 may be performed in accordance with examples as disclosed herein. In some examples, aspects of the operations of 1005 may be performed by a WUS configuration component 625 as described with reference to FIG. 6.

At 1010, the method may include transmitting an uplink WUS that requests an on-demand SIB1 and on-demand other system information based on the uplink WUS configuration. The operations of 1010 may be performed in accordance with examples as disclosed herein. In some examples, aspects of the operations of 1010 may be performed by a WUS transmission component 630 as described with reference to FIG. 6.

At 1015, the method may include receiving, in response to the uplink WUS, a random access response message that indicates scheduling information for the one or more second monitoring windows for the on-demand other system information or identifiers of one or more other system information that are triggered in response to the uplink WUS. The operations of 1015 may be performed in accordance with examples as disclosed herein. In some examples, aspects of the operations of 1015 may be performed by a random access response message component 650 as described with reference to FIG. 6.

At 1020, the method may include receiving the on-demand SIB1 during a first monitoring window based on the uplink WUS that requests the on-demand other system information and the on-demand SIB1. The operations of 1020 may be performed in accordance with examples as disclosed herein. In some examples, aspects of the operations of 1020 may be performed by an on-demand SIB1 component 635 as described with reference to FIG. 6.

At 1025, the method may include receiving the on-demand other system information during one or more second monitoring windows based on the uplink WUS that requests the on-demand other system information and the on-demand SIB1. The operations of 1025 may be performed in accordance with examples as disclosed herein. In some examples, aspects of the operations of 1025 may be performed by an on-demand other system information component 640 as described with reference to FIG. 6.

The following provides an overview of aspects of the present disclosure:

Aspect 1: A method for wireless communications at a UE, comprising: receiving a control signal indicating an uplink wake up signal configuration; transmitting an uplink wake up signal that requests an on-demand system information block 1 and on-demand other system information based at least in part on the uplink wake up signal configuration; receiving the on-demand system information block 1 during a first monitoring window based at least in part on the uplink wake up signal that requests the on-demand other system information and the on-demand system information block 1; and receiving the on-demand other system information during one or more second monitoring windows based at least in part on the uplink wake up signal that requests the on-demand other system information and the on-demand system information block 1.

Aspect 2: The method of aspect 1, wherein transmitting the uplink wake up signal comprises: transmitting assistance information associated with the on-demand other system information.

Aspect 3: The method of aspect 2, wherein the assistance information is based at least in part on a random access preamble used for the uplink wake up signal or random access channel resources used to transmit the uplink wake up signal.

Aspect 4: The method of any of aspects 2 through 3, wherein the assistance information indicates a system information area identifier, one or more value tags for one or more other system information, an RRC connection status of the UE, a first request for the on-demand system information block 1, a second request for the on-demand other system information and the on-demand system information block 1, or any combination thereof.

Aspect 5: The method of any of aspects 1 through 4, wherein the uplink wake up signal configuration identifies one or more other system information that are triggered in response to the uplink wake up signal that requests the on-demand system information block 1 and the on-demand other system information.

Aspect 6: The method of any of aspects 1 through 5, wherein the on-demand system information block 1 indicates scheduling information for the one or more second monitoring windows for the on-demand other system information.

Aspect 7: The method of any of aspects 1 through 6, further comprising: receiving, in response to the uplink wake up signal, a random access response message that indicates scheduling information for the one or more second monitoring windows for the on-demand other system information or identities of one or more other system information that are triggered in response to the uplink wake up signal.

Aspect 8: The method of aspect 7, wherein the random access response message indicates timing information, including a reference time and an offset from the reference time, for a third window that comprises the one or more second monitoring windows.

Aspect 9: The method of aspect 8, wherein the reference time corresponds to a reception of the random access response message, a start of a random access response window, or an end of the random access response window.

Aspect 10: The method of any of aspects 1 through 9, wherein the uplink wake up signal configuration indicates scheduling information or search space information for the one or more second monitoring windows for the on-demand other system information.

Aspect 11: The method of any of aspects 1 through 10, wherein the uplink wake up signal configuration includes a first configuration for a first random access channel resource associated with requesting the on-demand system information block 1and a second configuration for a second random access channel resource associated with requesting the on-demand system information block 1 and the on-demand other system information, the first random access channel resource and the second random access channel resource each include a random access preamble and a set of time and frequency resources

Aspect 12: The method of any of aspects 1 through 11, wherein the uplink wake up signal configuration indicates timing information, including a reference time and an offset from the reference time, for a third window that comprises the one or more second monitoring windows.

Aspect 13: The method of aspect 12, wherein the reference time corresponds to a reception of the on-demand system information block 1, a start of the first monitoring window, or an end of the first monitoring window.

Aspect 14: A UE for wireless communications, comprising one or more memories storing processor-executable code, and one or more processors coupled with the one or more memories and individually or collectively operable to execute the code to cause the UE to perform a method of any of aspects 1 through 13.

Aspect 15: A UE for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system configured to:
receive a control signal that indicates an uplink wake up signal configuration;
transmit an uplink wake up signal that requests an on-demand system information block 1 and on-demand other system information based at least in part on the uplink wake up signal configuration;
receive the on-demand system information block 1 during a first monitoring window based at least in part on the uplink wake up signal that requests the on-demand other system information and the on-demand system information block 1; and
receive the on-demand other system information during one or more second monitoring windows based at least in part on the uplink wake up signal that requests the on-demand other system information and the on-demand system information block 1.

2. The UE of claim 1, wherein, to transmit the uplink wake up signal, the processing system is configured to:
transmit assistance information associated with the on-demand other system information.

3. The UE of claim 2, wherein the assistance information is based at least in part on a random access preamble used for the uplink wake up signal or random access channel resources used to transmit the uplink wake up signal.

4. The UE of claim 2, wherein the assistance information indicates a system information area identifier, one or more value tags for one or more other system information, a radio resource control (RRC) connection status of the UE, a first request for the on-demand system information block 1, a second request for the on-demand other system information and the on-demand system information block 1, or any combination thereof.

5. The UE of claim 1, wherein the uplink wake up signal configuration identifies one or more other system information that are triggered in response to the uplink wake up signal that requests the on-demand system information block 1 and the on-demand other system information.

6. The UE of claim 1, wherein the on-demand system information block 1 indicates scheduling information for the one or more second monitoring windows for the on-demand other system information.

7. The UE of claim 1, wherein the processing system is configured to:
receive, in response to the uplink wake up signal, a random access response message that indicates scheduling information for the one or more second monitoring windows for the on-demand other system information or identifiers of one or more other system information that are triggered in response to the uplink wake up signal.

8. The UE of claim 7, wherein the random access response message indicates timing information, including a reference time and an offset from the reference time, for a third window that comprises the one or more second monitoring windows.

9. The UE of claim 8, wherein the reference time corresponds to a reception of the random access response message, a start of a random access response window, or an end of the random access response window.

10. The UE of claim 1, wherein the uplink wake up signal configuration indicates scheduling information or search space information for the one or more second monitoring windows for the on-demand other system information.

11. The UE of claim 1, wherein the uplink wake up signal configuration includes a first configuration for a first random access channel resource associated with a request for the on-demand system information block 1 and a second configuration for a second random access channel resource associated with a request for the on-demand system information block 1 and the on-demand other system information, wherein the first random access channel resource and the second random access channel resource each include a random access preamble and a set of time and frequency resources.

12. The UE of claim 1, wherein the uplink wake up signal configuration indicates timing information, including a reference time and an offset from the reference time, for a third window that comprises the one or more second monitoring windows.

13. The UE of claim 12, wherein the reference time corresponds to a reception of the on-demand system information block 1, a start of the first monitoring window, or an end of the first monitoring window.

14. A method of wireless communications performed by a user equipment (UE), comprising:
receiving a control signal indicating an uplink wake up signal configuration;
transmitting an uplink wake up signal that requests an on-demand system information block 1 and on-demand other system information based at least in part on the uplink wake up signal configuration;
receiving the on-demand system information block 1 during a first monitoring window based at least in part on the uplink wake up signal that requests the on-demand other system information and the on-demand system information block 1; and
receiving the on-demand other system information during one or more second monitoring windows based at least in part on the uplink wake up signal that requests the on-demand other system information and the on-demand system information block 1.

15. The method of claim 14, wherein transmitting the uplink wake up signal comprises:
transmitting assistance information associated with the on-demand other system information.

16. The method of claim 15, wherein the assistance information is based at least in part on a random access preamble used for the uplink wake up signal or random access channel resources used to transmit the uplink wake up signal.

17. The method of claim 15, wherein the assistance information indicates a system information area identifier, one or more value tags for one or more other system information, a radio resource control (RRC) connection status of the UE, a first request for the on-demand system information block 1, a second request for the on-demand other system information and the on-demand system information block 1, or any combination thereof.

18. The method of claim 14, wherein the uplink wake up signal configuration identifies one or more other system information that are triggered in response to the uplink wake up signal that requests the on-demand system information block 1 and the on-demand other system information.

19. The method of claim 14, wherein the on-demand system information block 1 indicates scheduling information for the one or more second monitoring windows for the on-demand other system information.

20. A non-transitory computer-readable medium having code for wireless communications stored thereon that, when executed by a user equipment (UE), causes the UE to:
receive a control signal indicating an uplink wake up signal configuration;
transmit an uplink wake up signal that requests an on-demand system information block 1 and on-demand other system information based at least in part on the uplink wake up signal configuration;
receive the on-demand system information block 1 during a first monitoring window based at least in part on the uplink wake up signal that requests the on-demand other system information and the on-demand system information block 1; and
receive the on-demand other system information during one or more second monitoring windows based at least in part on the uplink wake up signal that requests the on-demand other system information and the on-demand system information block 1.
